(19) United States
(12) Patent Application Publication
(10) Pub. No.: US 2026/0011505 A1
(43) Pub. Date: Jan. 8, 2026

(54) LAMINATED CERAMIC CAPACITOR AND METHOD OF MANUFACTURING LAMINATED CERAMIC CAPACITOR

(71) Applicant: TAIYO YUDEN CO., LTD., Tokyo (JP)

(72) Inventor: Hideya TERAOKA, Tokyo (JP)

(21) Appl. No.: 19/328,880

(22) Filed: Sep. 15, 2025

Related U.S. Application Data
(63) Continuation of application No. PCT/JP2024/003783, filed on Feb. 5, 2024.

(30) Foreign Application Priority Data
Mar. 16, 2023 (JP) 2023-042031

(51) Int. Cl. H01G 4/30; H01G 4/008; H01G 4/232

(52) U.S. Cl. CPC H01G 4/30; H01G 4/0085; H01G 4/2325

(57) ABSTRACT

A capacitor includes a body, a first external electrode provided on the body, and a second external electrode provided on the body. The body has: a first internal electrode layer containing Fe at a first concentration; a second internal electrode layer; a dielectric layer disposed between the first and second internal electrode layers in a first direction; and a first intermediate layer disposed between the first internal electrode layer and the dielectric layer, the first intermediate layer containing Fe at a second concentration. The first external electrode is electrically connected to the first internal electrode layer, and the second external electrode is electrically connected to the second internal electrode layer. The first external electrode includes a Ni plating layer. The first concentration is 0.01 at % or greater. The second concentration is equal to or greater than three times the first concentration while being 2 at % or less.

### CROSS-REFERENCE TO RELATED APPLICATIONS

This is a continuation application of a PCT application No. PCT/JP2024/3783 filed on Feb. 5, 2024, which is based on and claims the benefit of priority from Japanese Patent Application serial No. 2023-042031 (filed on Mar. 16, 2023). The contents of the PCT and Japanese applications are hereby incorporated by reference in their entirety.

### TECHNICAL FIELD

The disclosure herein relates mainly to a laminated ceramic capacitor and a method of manufacturing the laminated ceramic capacitor. The disclosure herein also relates to a circuit module with the laminated ceramic capacitor and an electronic device with the circuit module.

### BACKGROUND

The miniaturization of electronic devices has created a demand for increased capacitance in laminated ceramic capacitors, which are mounted in electronic devices, without an increase in the size of the capacitors. Laminated ceramic capacitors have a capacitance-generating portion that includes dielectric layers and internal electrode layers that sandwich the dielectric layers. By reducing the thickness of the dielectric layers, the capacitors can exhibit higher capacitance without an increase in the size of the capacitors.

However, thinner dielectric layers may lead to degraded insulation reliability of the capacitors. To address this issue, it has been proposed to improve the insulation reliability of the capacitors by providing intermediate layers containing trace amounts of metal elements between the dielectric layers and the internal electrode layers, so that the intermediate layers can increase the Schottky barrier between the dielectric layers and the internal electrode layers. For example, Japanese Patent Application Publication No. 2017-5021 (“the '021 Publication”) discloses that a metal element is added to an internal electrode layer and that the added metal element is present at a higher ratio at the interface between the internal electrode layer and a dielectric layer than in a middle region in the thickness direction of the internal electrode layer. The '021 Publication states that the local concentration of the added metal element at the interface between the internal electrode layer and the dielectric layer causes alloying between Ni, which is the main component of the internal electrode layer, and the added metal element at the interface. As a result, the capacitor can exhibit improved insulation reliability. As the metal element that can be added to increase the Schottky barrier between the dielectric layer and the internal electrode layer, the '021 Publication discloses Fe, V, Y, and Cu.

If intermediate layers containing Fe are formed between dielectric layers and internal electrode layers, Fe is likely to diffuse into the dielectric layers. Such incorporation of Fe into the dielectric layers may disadvantageously lead to a decrease in effective capacitance of the capacitor.

The amount of Fe added to the raw material may be reduced. This is expected to result in a reduced proportion of Fe in the dielectric layers, thereby preventing the decrease in effective capacitance. If the amount of Fe added to the raw material is reduced, however, the Schottky barrier formed between the dielectric layers and the internal electrode layers can not be sufficiently increased. This may lead to a drop in the insulation reliability of the capacitor.

### SUMMARY

It is an object of the present disclosure to solve or alleviate at least part of the drawback mentioned above. Particularly, it is an object of the present disclosure to prevent a decrease in effective capacitance of a capacitor including an Fe-containing intermediate layer. One of the more particular objects of the disclosure is to provide a capacitor that can combine excellent effective capacitance and high insulation reliability. The various inventions disclosed herein may be collectively referred to as “the invention”.

Other objects of the disclosure will be made apparent through the entire description in the specification. The invention disclosed herein may also address drawbacks other than that grasped from the above description. When an advantageous effect of an embodiment is described herein, the advantageous effect suggests an object of the invention corresponding to the embodiment.

An aspect of the present disclosure provides a capacitor including a body, a first external electrode provided on the body, and a second external electrode provided on the body. The body has: a first internal electrode layer containing a main component metal and Fe, the first internal electrode layer containing Fe at a first concentration; a second internal electrode layer; a dielectric layer disposed between the first and second internal electrode layers in a first direction; and a first intermediate layer disposed between the first internal electrode layer and the dielectric layer, the first intermediate layer containing Fe at a second concentration. The first external electrode is electrically connected to the first internal electrode layer, and the second external electrode is electrically connected to the second internal electrode layer. The first external electrode includes a Ni plating layer. The first concentration is 0.01 at % or greater. The second concentration is equal to or greater than three times the first concentration while being 2 at % or less.

### Advantageous Effects

According to one embodiment of the disclosure, a decrease in effective capacitance of a capacitor including an Fe-containing intermediate layer can be prevented.

### BRIEF DESCRIPTION OF THE DRAWINGS

FIG. 1 is a perspective view schematically showing a capacitor according to one embodiment of the disclosure.

FIG. 2 is a sectional view schematically showing a section of the capacitor of FIG. 1 along the line I-I.

FIG. 3 is an enlarged sectional view showing, on an enlarged scale, a part (region A) of the section shown in FIG. 2.

FIG. 4 is an enlarged sectional view showing, on an enlarged scale, a part (region B) of the section shown in FIG. 2.

FIG. 5 shows an example of a line profile obtained by EDS mapping.

FIG. 6 is a flowchart showing a flow of a manufacturing method of a capacitor according to one embodiment of the disclosure.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

For convenience of explanation, each of the drawings may show the L axis, the W axis, and the T axis orthogonal to one another. In this specification, the dimensions, arrangement, shape, and other features of each component of a laminated ceramic capacitor 1 may be described with reference to the L, W, and T axes.

### (1) Laminated Ceramic Capacitor 1

### (1-1) Basic Structure of Laminated Ceramic Capacitor 1

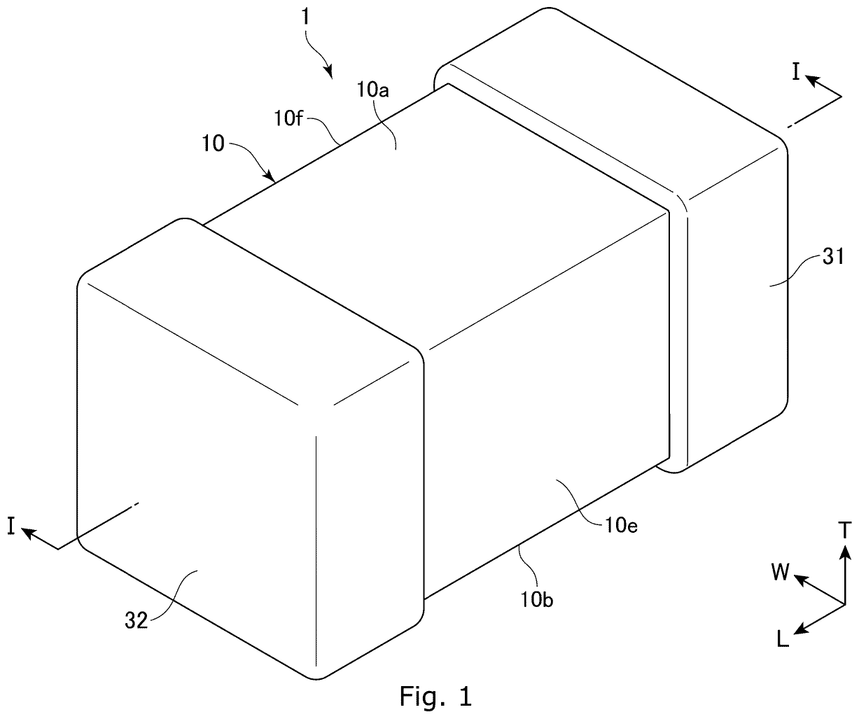

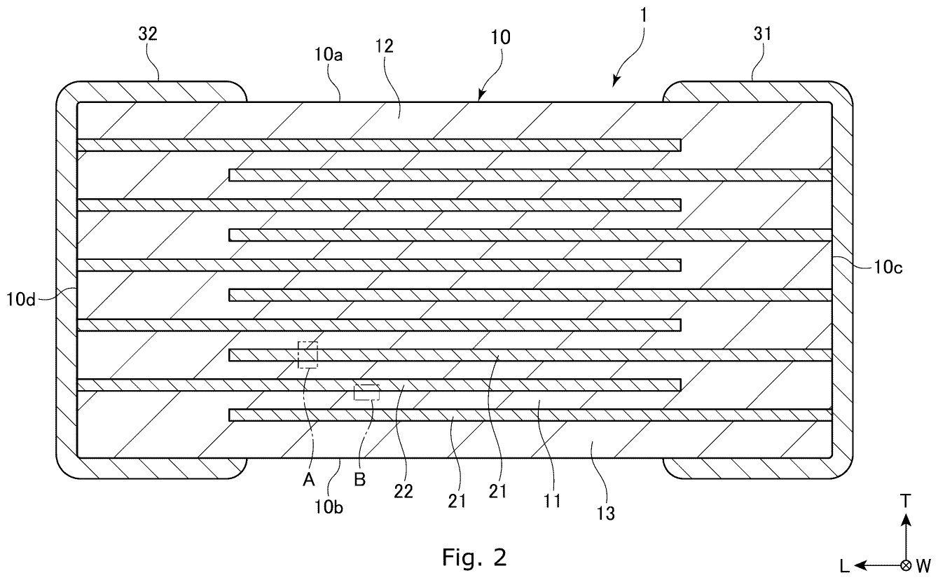

Referring to FIGS. 1 and 2, a description will now be given of the basic structure of a laminated ceramic capacitor 1 according to a first embodiment. FIG. 1 is a perspective view showing the laminated ceramic capacitor 1 according to the first embodiment. FIG. 2 is a sectional view schematically showing a section of the laminated ceramic capacitor 1 along the line I-I.

The laminated ceramic capacitor 1 has a body 10, and a first external electrode 31 and a second external electrode 32 provided on the body 10. The first external electrode 31 is spaced apart from the second external electrode 32. In the example shown in FIG. 2, the first external electrode 31 is spaced apart from the second external electrode 32 in the L-axis direction.

The body 10 has a top surface 10a, a bottom surface 10b, a first end surface 10c, a second end surface 10d, a first side surface 10e, and a second side surface 10f. The outer surface of the body 10 is defined by the top surface 10a, the bottom surface 10b, the first end surface 10c, the second end surface 10d, the first side surface 10e, and the second side surface 10f.

The top surface 10a and the bottom surface 10b form the opposite ends of the body 10 in the height direction (T-axis direction). In other words, the top surface 10a and the bottom surface 10b are opposed to each other in the T-axis direction. The first end surface 10c and the second end surface 10d form the opposite ends of the body 10 in the length direction (L-axis direction). In other words, the first end surface 10c and the second end surface 10d are opposed to each other in the L-axis direction. The first side surface 10e and the second side surface 10f form the opposite ends of the body 10 in the width direction (W-axis direction). In other words, the first side surface 10e and the second side surface 10f are opposed to each other in the W-axis direction. The top surface 10a and the bottom surface 10b are separated from each other by a distance equal to the height of the body 10, the first end surface 10c and the second end surface 10d are separated from each other by a distance equal to the length of the body 10, and the first side surface 10e and the second side surface 10f are separated from each other by a distance equal to the width of the body 10.

The body 10 includes a plurality of dielectric layers 11, a plurality of first internal electrode layers 21, and a plurality of second internal electrode layers 22. The body 10 is composed of the dielectric layers 11, the first internal electrode layers 21, and the second internal electrode layers 22 stacked together along the lamination direction. In the illustrated embodiment, the dielectric layers 11, the first internal electrode layers 21, and the second internal electrode layers 22 are stacked together along the T-axis direction. The lamination direction may be along the T axis, as shown in the drawings, or may be along the L or W axis. From among the plurality of dielectric layers 11, the dielectric layers 11 located at the opposite ends in the lamination direction may be referred to as cover layers. A dielectric layer 11 is present between a first internal electrode layer 21 and a second internal electrode layer 22 adjacent to the first internal electrode layer 21. In this specification, the first internal electrode layers 21 and the second internal electrode layers 22 may be referred to collectively as “the internal electrode layers” when it is not necessary to distinguish the first internal electrode layers 21 and the second internal electrode layers 22 from each other.

In the illustrated embodiment, the body 10 is constituted by the dielectric layers 11, the first internal electrode layers 21, and the second internal electrode layers 22 stacked together along the T-axis direction. Therefore, the T-axis direction may be referred to as the lamination direction. An upper cover layer 12 may be provided on the top surface of the laminate. A lower cover layer 13 may be provided on the bottom surface of the laminate. The upper cover layer 12 and the lower cover layer 13 may be formed of the same material as the dielectric layers 11. The upper cover layer 12 and the lower cover layer 13 may be a part of the body 10.

Each of the first internal electrode layers 21 has one end led toward the outside of the body 10. The first internal electrode layer 21 is connected to the first external electrode 31 provided on the surface of the body 10. Each of the second internal electrode layers 22 has one end led toward the outside of the body 10. The second internal electrode layer 22 is connected to the second external electrode 32 provided on the surface of the body 10. In the illustrated embodiment, the first internal electrode layer 21 is led out from one end of the body 10 in the L-axis direction toward the outside of the body 10. The first internal electrode layer 21 is connected to the first external electrode 31 at one end of the body 10 in the L-axis direction. The second internal electrode layer 22 is led out from the other end of the body 10 in the L-axis direction toward the outside of the body 10. The second internal electrode layer 22 is connected to the second external electrode 32 at the other end of the body 10 in the L-axis direction. In the example shown in FIG. 2, the first and second internal electrode layers 21 and 22 are respectively led out to the first and second end surfaces 10c and 10d, which are opposed to each other, but the first and second internal electrode layers 21 and 22 can be led out through various surfaces of the body 10 in accordance with the locations and the shapes of the first and second external electrodes 31 and 32. For example, if both the first and second external electrodes 31 and 32 are located on the bottom surface 10b, both the first and second internal electrode layers 21 and 22 are led out through the bottom surface. The first and second external electrodes 31 and 32 may be located on any of the surfaces of the body 10 as long as they are separated from each other.

When voltage is applied between the first and second external electrodes 31 and 32, capacitance is generated between the first and second internal electrode layers 21 and 22.

As will be described later, first intermediate layers 41 containing Fe are located between the dielectric layers 11 and the first internal electrode layers 21, and second intermediate layers 42 containing Fe are located between the dielectric layers 11 and the second internal electrode layers 22, but FIGS. 1 and 2 do not show the first intermediate layers 41 and the second intermediate layers 42.

FIG. 2 shows five each of the first and second internal electrode layers 21 and 22 for simplicity of illustration, but the laminated ceramic capacitor 1 may include any number of layers stacked together. The laminated ceramic capacitor 1 may include, for example, 300 to 1000 layers formed of the first and second internal electrode layers 21 and 22. In other words, the number of stacked layers in the laminated ceramic capacitor 1 may be 300 to 1000.

The laminated ceramic capacitor 1 may be mounted on an electronic circuit board. The electronic circuit board having the laminated ceramic capacitor 1 mounted thereon may be referred to as a circuit module. Various electronic components other than the laminated ceramic capacitor 1 may also be mounted on the circuit module. The circuit module may be installed in various electronic devices. The electronic devices in which the circuit module can be installed include smartphones, tablets, game consoles, electrical components of automobiles, servers, and various other electronic devices.

In one aspect, the body 10 may be configured to have a rectangular parallelepiped shape. The term “rectangular parallelepiped” or “rectangular parallelepiped shape” used herein is not intended to mean solely “rectangular parallelepiped” in a mathematically strict sense. As described below, the corners and/or edges of the body 10 may be rounded. The dimensions and the shape of the body 10 are not limited to those specified herein.

In one aspect, the laminated ceramic capacitor 1 has a dimension in the L-axis direction (length) of 0.2 mm to 2.5 mm, a dimension in the W-axis direction (width) of 0.1 mm to 3.5 mm, and a dimension in the T-axis direction (height) of 0.1 mm to 3.0 mm. In one aspect, the length of the laminated ceramic capacitor 1 may be larger than the width thereof. In one aspect, the height of the laminated ceramic capacitor 1 may be larger than the width thereof. In one aspect, the width of the laminated ceramic capacitor 1 may be larger than the length thereof.

### (1-2) Dielectric Layer 11

The dielectric layers 11 contain as their main component an oxide represented by a chemical formula ABO₃. The oxide may have a perovskite structure. A component that is at least 50 wt % of the dielectric layers 11 with reference to the total mass of the dielectric layers 11 can be regarded as the main component of the dielectric layers 11. When the dielectric layers 11 contain 50 wt % or more of the oxide represented by the chemical formula ABO₃, the dielectric layers 11 can be considered to contain the oxide represented by the chemical formula ABO₃ as their main component. The dielectric layers 11 preferably contain at least 60 wt %, 70 wt %, 80 wt %, or 90 wt % of the oxide represented by the chemical formula ABO₃.

In the chemical formula ABO₃, “A” is at least one element selected from the group consisting of Ba (barium), Sr (strontium), Ca (calcium), and Mg (magnesium). In the chemical formula ABO₃, “B” is at least one element selected from the group consisting of Ti (titanium), Zr (zirconium), and Hf (hafnium). When the oxide represented by the chemical formula ABO₃ has a perovskite structure, the elements “A” and “B” are located at the A site and the B site of the perovskite structure, respectively. Examples of the oxide contained in the dielectric layers 11 as their main component include BaTiO₃ (barium titanate), CaZrO₃ (calcium zirconate), CaTiO₃ (calcium titanate), SrTiO₃ (strontium titanate), and MgTiO₃ (magnesium titanate).

The oxide contained in the dielectric layers 11 as the main component may be an oxide represented by the chemical formula Ba_{1-x-y}CaₓSr_{y}Ti_{1-z}Zr_{z}O₃ (0≤x≤1, 0≤y≤1, 0≤z≤1). Examples of this type of oxide include strontium barium titanate, calcium barium titanate, barium zirconate, barium zirconate titanate, calcium zirconate titanate, and calcium barium zirconate titanate.

The dielectric layers 11 may contain one or more additive elements in addition to the main component oxide. In one aspect, the one or more additive elements contained in the dielectric layers 11 are selected from the group consisting of Fe (iron), Ni (nickel), Mo (molybdenum), Nb (niobium), Ta (tantalum), W (tungsten), Mg (magnesium), Mn (manganese), V (vanadium), and Cr (chromium). The dielectric layers 11 may contain two or more of the above additive elements.

The dielectric layers 11 may contain oxides of rare earth elements in addition to the main component oxide. The oxides of rare earth elements contained in the dielectric layers 11 may be oxides of at least one rare earth element selected from the group consisting of Y (yttrium), Sm (samarium), Eu (europium), Gd (gadolinium), Tb (terbium), Dy (dysprosium), Ho (holmium), Er (erbium), Tm (thulium), and Yb (ytterbium). The dielectric layers 11 may contain oxides of two or more rare earth elements.

The dielectric layers 11 may contain yet another type of oxide. The dielectric layers 11 may contain oxides of at least one element selected from the group consisting of, for example, Co (cobalt), Ni (nickel), Li (lithium), B (boron), Na (sodium), K (potassium), and Si (silicon). The dielectric layers 11 may contain oxides of two or more of these elements.

The dielectric layers 11 may contain glass containing at least one element selected from the group consisting of Co, Ni, Li, B, Na, K, and Si.

In one aspect, the thickness (the dimension in the T-axis direction) of each dielectric layer 11 is 0.2 μm to 10 μm.

### (1-3) First Internal Electrode Layers 21 and Second Internal Electrode Layers 22

In one aspect, the first internal electrode layers 21 contain Ni (nickel) as the main component thereof. A component that is at least 50 wt % of the first internal electrode layers 21 with reference to the total mass of the first internal electrode layers 21 can be regarded as the main component of the first internal electrode layers 21. The first internal electrode layers 21 preferably contain 60 wt % or more, 70 wt % or more, 80 wt % or more, or 90 wt % or more a base metal as the main component thereof.

The first internal electrode layers 21 contain Fe in addition to Ni. The first internal electrode layers 21 can contain a secondary element in addition to Ni and Fe. The secondary element that can be contained in the first internal electrode layers 21 is one or more elements selected from the group consisting of, for example, As (arsenic), Au (gold), Co, Cr, Cu, Fe, In (indium), Ir (iridium), Mg, Os (osmium), Pd (palladium), Pt (platinum), Re (rhenium), Rh (rhodium), Ru (ruthenium), Se (selenium), Sn, Ge (germanium), Te (tellurium), W, Y (yttrium), Zn (zinc), Ag (silver), and Mo.

The description of the components of the first internal electrode layers 21 also applies to the components of the second internal electrode layers 22.

In an aspect, the thickness (the dimension in the T-axis direction) of each first internal electrode layer 21 and the thickness (the dimension in the T-axis direction) of each second internal electrode layer 22 are both 0.1 μm to 2 μm. The description of the thickness of each first internal electrode layer 21 also applies to the thickness of each second internal electrode layer 22.

### (1-4) First External Electrode 31 and Second External Electrode 32

In one aspect, the first and second external electrodes 31 and 32 are formed by applying a conductive paste to the body 10 and heating the conductive paste. The conductive paste can contain at least one substance from the group consisting of Ag, Pd, Au, Pt, Ni, Sn, Cu, W, Ti, and alloys of these.

The first external electrode 31 may include an Ni plated layer. The Ni plated layer can be formed by the electrolytic or electroless plating method on the surface of a base electrode layer that is formed by heating a conductive paste. Similarly, the second external electrode 32 can also include an Ni plated layer.

### (1-5) First Intermediate Layer 41 and Second Intermediate Layer 42

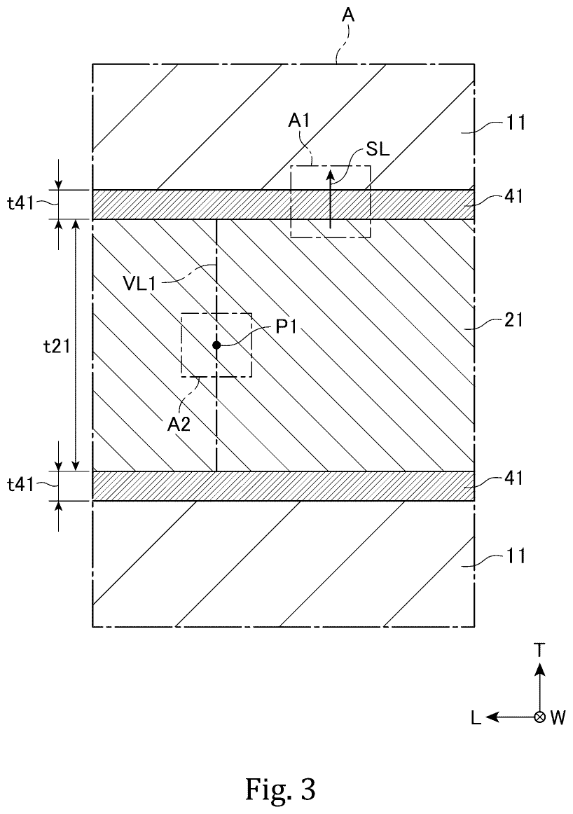

Next, with further reference to FIGS. 3 to 5, a description is given of the first intermediate layers 41 and the second intermediate layers 42.

The first intermediate layers 41 will now be described with reference to FIG. 3. FIG. 3 is an enlarged sectional view showing, on an enlarged scale, a region A of the section of the body 10 shown in FIG. 2. The region A includes a given one of the first internal electrode layers 21 provided in the body 10 and the dielectric layers 11 above and below the given first internal electrode layer 21. Stated differently, the region A extends from the dielectric layer 11 below the first internal electrode layer 21, over the first internal electrode layer 21, and to the dielectric layer 11 above the first internal electrode layer 21. The thickness t21 of the first internal electrode layer 21 may be from 0.1 μm to 2 μm, as mentioned above.

As shown in the drawing, a first intermediate layer 41 containing Fe is provided between a dielectric layer 11 and a first internal electrode layer 21. The first intermediate layer 41 allows for a higher Schottky barrier to be formed between the dielectric layer 11 and the first internal electrode layer 21. The increased height of the Schottky barrier formed between the dielectric layer 11 and the first internal electrode layer 21 can prevent occurrence of leakage current, as a result of which the laminated ceramic capacitor 1 can achieve improved insulation reliability. In other words, the service life of the laminated ceramic capacitor 1 can be extended.

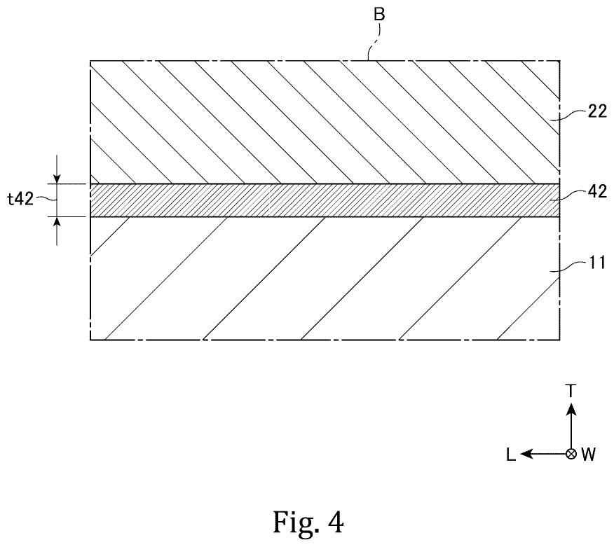

The second intermediate layers 42 will now be described with reference to FIG. 4. FIG. 4 is an enlarged sectional view showing, on an enlarged scale, a region B of the section of the body 10 shown in FIG. 2. The region B extends from a given one of the second internal electrode layers 22 included in the body 10 to the dielectric layer 11 below the given second internal electrode layer 22.

As shown in FIG. 4, a second intermediate layer 42 containing Fe is provided between the dielectric layer 11 and the second internal electrode layer 22. The second intermediate layer 42 can increase the height of the Schottky barrier formed between the dielectric layer 11 and the second internal electrode layer 22, thereby allowing the laminated ceramic capacitor 1 to exhibit improved insulation reliability.

The thickness t41 (dimension in the lamination direction) of each first intermediate layer 41 is, for example, 0.2 nm to 3.0 nm. The lower limit of the thickness t41 of the first intermediate layer 41 may be 0.3 nm, 0.4 nm, or 0.5 nm. The upper limit of the thickness t41 of the first intermediate layer 41 may be 2.0 nm, 1.5 nm, or 1.3 nm. The thickness t42 of each second intermediate layer 42 may be comparable to the thickness t41 of the first intermediate layer 41.

In the illustrated embodiment, the body 10 includes the first intermediate layers 41 and the second intermediate layers 42. This configuration allows the Schottky barrier to be increased in both the regions between the dielectric layers 11 and the first internal electrode layers 21 and the regions between the dielectric layers 11 and the second internal electrode layers 22. In one aspect, it is possible that the body 10 includes the first intermediate layers 41 but does not include the second intermediate layers 42. In this case, the Schottky barrier between the dielectric layers 11 and the first internal electrode layers 21 can be increased. In one aspect, it is possible that the body 10 includes the second intermediate layers 42 but does not include the first intermediate layers 41. In this case, the Schottky barrier between the dielectric layers 11 and the second internal electrode layers 22 can be increased.

The first intermediate layer 41 may cover the entire first internal electrode layer 21. The first intermediate layer 41 may cover only a part of the first internal electrode layer 21. The first intermediate layers 41 preferably cover 80% or more of the top and bottom surfaces of the first internal electrode layers 21 to reduce leakage current. Likewise, each second intermediate layer 42 may entirely cover a corresponding second internal electrode layer 22. Each second intermediate layer 42 may cover only a portion of the corresponding second internal electrode layer 22. The second intermediate layers 42 preferably cover 80% or more of the top and bottom surfaces of the second internal electrode layers 22 to reduce leakage current.

If the first intermediate layers 41 are not visible in electron microscope images, the presence of the first intermediate layers 41 can be confirmed as follows. An observation region extending from a first internal electrode layer 21 to a dielectric layer 11 is set on a section of the body 10 and subjected to Transmission Electron Microscope-Energy Dispersive X-ray Spectroscopy (TEM-EDS) to obtain mapping data of the qualitative element. The observation region can be, for example, the region A indicated in FIG. 3. The detection of the first intermediate layers 41 by TEM-EDS analysis can proceed, for example, as follows.

(1) An analysis specimen is prepared by thinly slicing the body 10 such that a surface parallel to the plane containing the T-axis (e.g., LT plane) is exposed as an observation surface, and an observation region A1 spanning from a first internal electrode layer 21 to a dielectric layer 11 is set on the observation surface of the thinly sliced analysis sample. The observation region A1 is then subjected to TEM-EDS to obtain mapping data of the qualitative elements contained in the observation region A1. The observation region A1 is, for example, a square region with sides of 15 nm. The quantitative elements include the elements contained in the main component oxide of the dielectric layer 11 (e.g., Ba, Ti, and O when the main component oxide is BaTiO₃), Ni, which is the main component metal of the first internal electrode layer 21, and Fe.

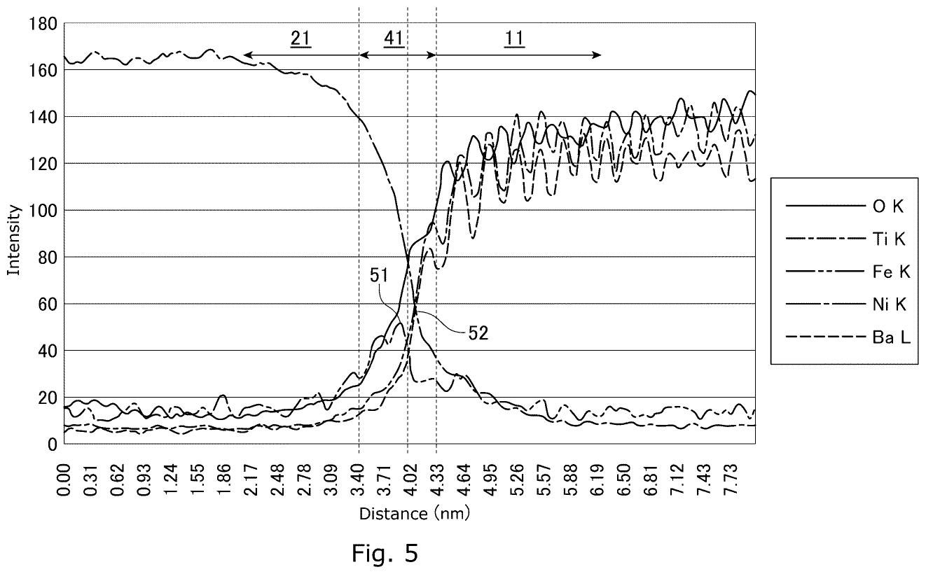

(2) Next, a line analysis is performed based on the obtained mapping data. Specifically, the mapping data of the quantitative elements are reconstructed along a scanning line SL that extends in the observation region A1 from the first internal electrode layer 21 to the dielectric layer 11, thereby creating line profiles for the respective quantitative elements. The length of the scanning line SL is 8 nm, for example. The length of the scanning line for obtaining the line profiles can be changed appropriately. FIG. 5 shows an example of the line profiles reconstructed along the scanning line SL from the mapping data obtained by TEM-EDS in the observation region A1 of the analysis specimen. The line profiles in FIG. 5 are the graphs obtained as follows: an analysis specimen is prepared from the laminated ceramic capacitor 1 including the dielectric layers 11 that are principally composed of BaTiO₃, and subjected to TEM-EDS to obtain mapping data of the elements including Ba, Ti, O, Ni and Fe, and the mapping data is then reconstructed along a scanning line SL. In FIG. 5, the horizontal axis represents the detection position on the scanning line SL, and the vertical axis represents the detection intensities calculated based on the counts of Ba, Ti, O, Ni and Fe at the detection positions.

(3) If the peak of the line profile of Fe is located in the vicinity of the intersection where the line profile of the non-oxygen element of the main component oxide of the dielectric layer 11 (e.g., Ba) intersects with the line profile of Ni, which is the main component of the first internal electrode layer 21 (hereinafter referred to as “profile intersection”), it can be determined that a first intermediate layer 41 exists in the laminated ceramic capacitor 1 from which the analysis specimen is taken. For example, if the distance between the position of the profile intersection and the position of the peak of the Fe line profile is equal to or less than a predetermined threshold value, the peak of the Fe line profile can be determined to be in the vicinity of the profile intersection. The predetermined threshold value can be, for example, 1 nm, 0.9 nm, 0.8 nm, 0.7 nm, 0.6 nm or 0.5 nm.

In the example shown in FIG. 5, the line profile of Ba in BaTiO₃ contained as the main component in the dielectric layer 11 intersects the line profile of Ni contained as the main component in the first internal electrode layer 21 at about 4.1 nm from the scanning start position. In other words, the profile intersection 52 where the Ba line profile intersects the Ni line profile is about 4.1 nm from the scanning start position. Here, the peak 51 of the Fe line profile is located at about 3.9 nm from the scanning start position. Since the peak 51 of the Fe line profile is located about 0.2 nm away from the profile intersection 52, which is less than the threshold value, it is determined that a first intermediate layer 41 exists in the region including the peak 51. In the same manner as described above, it can be confirmed that the second intermediate layers 42 are present between the dielectric layers 11 and the second internal electrode layers 22.

If a peak appears in the line profile of Fe, the positions on both sides of the peak of the line profile at which the count value (or the intensity) is half the peak count value (the peak intensity value) can be regarded as the boundary between the first intermediate layer 41 and the dielectric layer 11 and the boundary between the first intermediate layer 41 and the first internal electrode layer 21. In the same manner, the boundary between the second intermediate layer 42 and the dielectric layer 11 and the boundary between the second intermediate layer 42 and the second internal electrode layer 22 can be determined.

In this specification, the first intermediate layers 41 and the second intermediate layers 42 may be referred to collectively as “the intermediate layers” when it is not necessary to distinguish the first intermediate layers 41 and the second intermediate layers 42 from each other.

### (1-6) Fe Concentration

The following now describes the Fe concentration in the first intermediate layers 41 and the first internal electrode layers 21.

The following first describes the Fe concentration in the first intermediate layers 41. As described above, since the first intermediate layers 41 containing Fe are provided between the dielectric layers 11 and the first internal electrode layers 21, the height of the Schottky barrier formed between the dielectric layers 11 and the first internal electrode layers 21 can be increased. This allows the laminated ceramic capacitor 1 to exhibit improved insulation reliability. The first intermediate layers 41 are formed as follows. While the internal electrode patterns, which are the precursor of the first internal electrode layers 21, are fired, Fe diffuses from within the internal electrode patterns toward the interfaces between the internal electrode patterns and the dielectric green sheets, which are the precursor of the dielectric layers 11, as will be described below, and are concentrated at the interfaces. By increasing the amount of Fe that diffuses from within the internal electrode patterns toward the interfaces, the Fe concentration can be increased in the first intermediate layers and the Schottky barrier can be increased. Here, some of the Fe that diffuses from within the internal electrode patterns toward the interfaces even reaches the inside of the dielectric green sheets. The Fe that diffuses into the dielectric green sheets is solidly soluble in the main component oxide (e.g., the B site of BaTiO₃) in the dielectric layers 11 after firing and inhibits the polarization reversal of the main component oxide, causing a decrease in the effective capacitance of the laminated ceramic capacitor 1. If the Fe concentration in the first intermediate layers 41 is increased, the amount of Fe incorporated into the dielectric layers 11 will increase accordingly. As a result, the effective capacitance of the laminated ceramic capacitor 1 will decrease.

As noted, there is a trade-off between the improvement in insulation reliability that is achieved by providing the first intermediate layers 41 to increase the Schottky barrier between the first internal electrode layers 21 and the dielectric layers 11, and the reduction in effective capacitance. Therefore, it is desirable to improve the insulation reliability of the laminated ceramic capacitor 1 through a mechanism different than increasing the Schottky barrier by increasing the Fe concentration in the first intermediate layers 41.

The inventor of the present application has discovered that, when the first external electrode 31 includes a Ni plated layer, the insulation reliability of the laminated ceramic capacitor 1 can be improved by incorporating 0.01 at % or more of Fe into the first internal electrode layers 21. The mechanism by which the insulation reliability of the laminated ceramic capacitor 1 is improved by incorporating 0.01 at % or more of Fe into the first internal electrode layers 21 is considered to be as follows. When the Ni plated layer is formed on the surface of the base electrode layer of the first external electrode 31 by electrolytic plating, the base electrode layer functions as the cathode, resulting in the generation of hydrogen gas around it, which is then absorbed into the base electrode layer. The base electrode layer is connected to the first internal electrode layers 21, which are primarily composed of Ni, an element that readily absorbs hydrogen. Therefore, hydrogen absorbed into the base electrode layer can migrate to the first internal electrode layers 21, where it is further absorbed by the large amount of Ni present. When the laminated ceramic capacitor 1 is in use, the hydrogen absorbed in the first internal electrode layers 21 diffuses into the dielectric layers 11 and releases electrons in the dielectric layers 11, thereby compromising the insulating property of the dielectric layers 11. Therefore, if a large amount of hydrogen is incorporated into the first internal electrode layers 21, the insulation reliability of the laminated ceramic capacitor 1 will drop. According to the inventor's research, if the first internal electrode layers 21 contain 0.01 at % or more of Fe, it can effectively suppress transition deformation of the metal lattice in the internal electrodes during formation of the Ni plated layer, thereby reducing hydrogen absorption in the first internal electrode layers 21. Accordingly, degradation in the insulation reliability of the laminated ceramic capacitor 1 due to the hydrogen absorbed in the first internal electrode layers 21 can be suppressed.

In one aspect, the first internal electrode layers 21 contain Fe at a first concentration that is 0.01 at % or greater, and the first intermediate layers 41 contain Fe at a concentration that is equal to or greater than three times the first concentration and no more than 2 at %. Since the concentration of Fe in the first intermediate layers 41 (second concentration) is kept as low as no more than 2 at %, the diffusion of Fe into the dielectric layers 11 can be suppressed, thereby preventing a drop in effective capacitance of the laminated ceramic capacitor 1. Since the second concentration is equal to or greater than three times the concentration of Fe in the first internal electrode layers 21 (first concentration), the Schottky barrier formed between the dielectric layers 11 and the first internal electrode layers 21 can be increased, thereby allowing the laminated ceramic capacitor 1 to exhibit improved insulation reliability. In addition, the first internal electrode layers 21 contain Fe at the first concentration that is equal to or greater than 0.01 at %, it can prevent degradation in insulation reliability that is attributable to the diffusion of hydrogen from the first internal electrode layers 21.

In one aspect, the second internal electrode layers 22 contains Fe at a third concentration that is 0.01 at % or greater, and the second intermediate layers 42 contain Fe at a fourth concentration that is equal to or greater than three times the third concentration and no more than 2 at %. This can result in the increased height of the Schottky barrier formed between the dielectric layers 11 and the second internal electrode layers 22, thereby allowing the laminated ceramic capacitor 1 to exhibit improved insulation reliability. In addition, since the second internal electrode layers 22 contain Fe at the third concentration that is equal to or greater than 0.01 at %, it can prevent degradation in insulation reliability that is attributable to the diffusion of hydrogen from the second internal electrode layers 22.

The following now describes the concentration of Fe in the first internal electrode layers 21. In one aspect, the concentration of Fe is quantified for a partial region within the first internal electrode layers 21, and the quantified Fe concentration for this partial region can be used as the concentration of Fe in the first internal electrode layers 21. For example, FIG. 3 shows a region A2 near the middle in the T-axis direction (the lamination direction) of a first internal electrode layer 21. The region A2 is defined to include a midpoint P1 of an imaginary line segment VL1 in the T-axis direction, where the imaginary line segment VL1 extends from one end to the other end of the first internal electrode layer 21 along the T-axis. The region A2 is, for example, a square region with sides of 15 nm. The concentration of Fe in the region A2 can be taken as the concentration of Fe in the first internal electrode layers 21. A plurality of regions A2 may be defined in the first internal electrode layer 21, and the average of the concentrations of Fe in the respective regions A2 may be taken as the concentration of Fe in the first intermediate layers 21. The concentration of Fe in the second internal electrode layers 22 can be calculated in the same manner as that in the first internal electrode layers 21.

The concentration of Fe contained in the first internal electrode layers 21 means the atomic ratio (at %) of Fe element to 100 at % of Ni element or the main component of the first internal electrode layers 21. As used herein, the Fe concentration (at %) is expressed as the atomic ratio of Fe element to 100 at % of the main component metal element (e.g., Ni element) in the first internal electrode layers 21, unless otherwise specified.

The Fe concentration in the internal electrode layers (i.e., first and second internal electrode layers 21 and 22), first intermediate layers 41, and second intermediate layers 42 can be determined by known analytical methods. The known analytical methods can include TEM-EDS, STEM-EDS, 3 Dimensional Atom Probe (3DAP) analysis, and Secondary Ion Mass Secondary Ion Mass Spectrometry (SIMS).

### (2) Manufacturing Method of Laminated Ceramic Capacitor 1

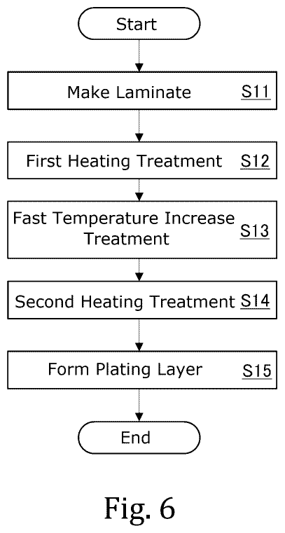

A description will now be given of one example of the manufacturing method of the laminated ceramic capacitor 1 with reference to FIG. 6. FIG. 6 is a flowchart showing a flow of a manufacturing method of a capacitor according to one embodiment of the disclosure.

A brief description is given of the manufacturing method shown in FIG. 6. To begin with, in the step S11, a laminate is made as the precursor of the body 10. The laminate includes dielectric green sheets, which are the precursor of the dielectric layers 11, and internal electrode patterns, which are the precursor of the first and second internal electrode layers 21 and 22. The internal electrode patterns contain Ni and Fe. Subsequently, the laminate is fired in the steps S12 to S14, and Ni plating is performed in the step S15 on the external electrodes of the fired body resulting from the firing. In this manner, the laminated ceramic capacitor 1 is made.

The following describes each of the steps shown in FIG. 6 in more detail. First, in the step S11, dielectric powder is wet-mixed with a binder such as polyvinyl butyral (PVB) resin, an organic solvent such as ethanol or toluene, and a plasticizer to obtain a slurry. This slurry is coated on a substrate film using, for example, the die coater or doctor blade method, and then the slurry coated on the substrate film is dried, to obtain a dielectric green sheet. The dielectric green sheets are the precursor of the dielectric layers 11.

The dielectric powder used as the raw powder of the dielectric green sheets is, for example, barium titanate powder. Barium titanate powder is synthesized by reacting titanium raw material such as titanium dioxide with barium raw material such as barium carbonate by a known method such as the solid phase method, the sol-gel method, or the hydrothermal method.

Next, an internal electrode pattern is formed on each of the dielectric green sheets formed as described above. The internal electrode pattern is formed, for example, by printing a paste for the internal electrodes on the dielectric green sheet using screen printing or other known printing methods. When the internal electrode patterns are formed by screen printing, the paste for the internal electrodes is produced by kneading and mixing a metal powder, a binder resin, and a solvent by a three-roll mill. In other words, the paste for the internal electrodes is a binder resin containing a metal powder dispersed therein. The metal powder contained in the paste for the internal electrodes may be a powder mixture produced by mixing Ni powder, which is the main component of the first and second internal electrode layers 21 and 22, with an Fe-containing powder, which contains Fe. The Fe-containing powder is, for example, Fe₂O₃ powder. The Fe-containing powder is weighed such that the ratio of Fe to 100 at % of Ni is 0.02 to 4.0 at % and the weighed Fe-containing powder is mixed with the Ni powder.

The organic binder used in the paste for the internal electrodes may be a cellulose-based resin such as ethyl cellulose or an acrylic resin such as butyl methacrylate. The internal electrode patterns formed on some of the dielectric green sheets are the precursor of the first internal electrode layers 21, and the internal electrode patterns formed on the others of the dielectric green sheets are the precursor of the second internal electrode layers 22.

The method of forming the internal electrode patterns is not limited to that specified herein. The internal electrode pattern may be formed by various known methods, e.g., sputtering, vacuum deposition, PLD (pulsed laser deposition), MO-CVD (metal organic chemical vapor deposition), MOD (metal organic decomposition), or CSD (chemical solution deposition).

As described above, a lamination unit having a dielectric green sheet and an internal electrode pattern formed on the surface of the dielectric green sheet is obtained. A predetermined number of lamination units are stacked together and thermo-compressed to form a laminate. The top layer and the bottom layer of the laminate may be formed of green sheets that do not have internal electrode patterns formed thereon.

Next, the laminate is diced into pieces to obtain chip-like laminates each being the precursor of the body 10. The chip-like laminates may be subjected to a degreasing process. The degreasing process may be performed in an N₂ atmosphere. The laminates having undergone the degreasing process may be coated with a metal paste by the dip method to form base electrode layers for the first and second external electrodes 31 and 32.

Next, in the step S12, the chip laminate produced in the step S11 is placed into a firing furnace, so that firing starts for the chip laminate. In the firing furnace, a low oxygen atmosphere with an oxygen partial pressure of 10-10 to 10-9 atm is maintained, for example. In the step S12, the temperature in the firing furnace is first raised from the room temperature to a firing start temperature at the rate of 200 to 1000° C./h and kept at the firing start temperature for 10 minutes to one hour. In other words, in the step S12, the chip laminate is heated at the firing start temperature for 10 minutes to one hour. The firing start temperature is set at 850 to 1100° C. where Ni can be sintered.

In the next step S13, a reducing atmosphere with an oxygen partial pressure of approximately 10-12 to 10-10 atm is maintained in the firing furnace, and the temperature in the firing furnace is increased at a fast rate from the firing start temperature to a firing top temperature. The firing top temperature is, for example, 1150 to 1300° C. The temperature increase rate is, for example, 3000 to 10000° C./h. An example of the temperature increase rate is 3000° C./h. When the temperature increase rate is as high as approximately 3000 to 10000° C./h, diffusion of Fe from the internal electrode patterns to the dielectric green sheets can be prevented. In this way, the first and second intermediate layers 41 and 42 resulting from the firing can be prevented from containing an excessive amount of Fe.

In the subsequent step S14, the temperature in the firing furnace is kept at the firing top temperature for 10 to 30 minutes to additionally heat the chip laminate. After the heating treatment in the step S14, the temperature in the firing furnace is lowered. The heating treatment in the step S14 fires the chip laminate into a fired body. The heating treatment in the step S14 fires the dielectric green sheets in the chip laminate into the dielectric layers 11 and the internal electrode patterns into the internal electrode layers (the first internal electrode layers 21 and the second internal electrode layers 22). During the firing process in the steps S12 to S14, the Fe contained in the internal electrode patterns thermally diffuses toward the interfaces between the internal electrode patterns and the dielectric green sheets. In this way, the first and second intermediate layers 41 and 42, which contain Fe at a higher concentration than the internal electrode layers, are respectively formed between the dielectric layers 11 and the first internal electrode layers 21 and between the dielectric layers 11 and the second internal electrode layers 22, in the fired body.

In the next step S15, a Ni plated layer is formed on the surface of the base electrode layers of the fired body. The Ni plated layer can be formed by the electrolytic or electroless plating method. A Sn plated layer may be formed on the surface of the base electrode layers, in addition to the Ni plated layer.

Through the above-described series of steps, the laminated ceramic capacitor 1 can be completed.

Processes not shown in the flowchart of FIG. 6 may be performed to produce the laminated ceramic capacitor 1. For example, the fired body resulting from the step S14 may be subjected to re-oxidation treatment at 600° C. to 1000° C. in an N₂ gas atmosphere or a low oxygen atmosphere.

### (3) Examples

The invention will now be further described in detail based on examples. The invention is not limited to the following examples.

### (3-1) Preparation of Samples

Sample 1, which is a laminated ceramic capacitor, was prepared according to the manufacturing method shown in FIG. 6, as follows. A slurry was first obtained by wet-mixing barium titanate powder with polyvinyl butyral (PVB) resin, a solvent, and a plasticizer. The slurry was coated on a substrate film, and then the slurry coated on the substrate film was dried to obtain a dielectric green sheet. Next, Ni powder having an average particle size of 200 nm was mixed with Fe₂O₃ powder to prepare a powder mixture. The Fe₂O₃ powder was weighed considering the atmosphere and temperature profile of the firing process such that the concentration of Fe in the internal electrodes of the laminated ceramic capacitor after the firing process would become 0.01 at % to 100 at % Ni. The Fe₂O₃ powder thus weighed was mixed with the Ni powder. Next, the powder mixture was wet-mixed with polyvinyl butyral (PVB) resin, a solvent, and a plasticizer to obtain a slurry for the internal electrodes. Then, the slurry for the internal electrodes was printed on a part of the surface of each dielectric green sheet, to form an internal electrode pattern on the dielectric green sheet. In this way, a lamination unit was made. The lamination unit had the dielectric green sheet and the internal electrode pattern formed on the surface of the dielectric green sheet.

Next, 500 lamination units were stacked together to form a laminate, which was then diced into chip laminates. The chip laminates had the 1005 shape (length: 1.0 mm, width: 0.5 mm, height: 0.5 mm). Next, the chip laminates were degreased in an N₂ atmosphere. Next, the base electrode layers of the external electrodes were formed on each of the chip laminates by applying metal paste to the degreased chip laminate by the dip method.

Next, the chip laminates obtained as described above were put into a firing furnace, and the chip laminates were fired according to a predetermined temperature profile and under predetermined firing conditions. Specifically, a low oxygen atmosphere with an oxygen partial pressure of 10-10 atm was maintained in the firing furnace, and the temperature in the firing furnace was increased from room temperature to 850° C. at a rate of 300° C./h and held at 850° C. for 30 minutes. After this, a reducing atmosphere with an oxygen partial pressure of 10-12 atm was established in the firing furnace, and the temperature in the firing furnace was increased from 850° C. to 1250° C. at a rate of 3000° C./h, held at 1250° C. for 30 minutes, and then decreased. A Ni plated layer was formed by electrolytic plating on the base electrode layers of the fired body resulting from the firing process performed with the above-described temperature profile. In the above-described manner, sample 1 was prepared.

Samples 2 to 7 were also prepared in the same manner as sample 1, except for the amount of the Fe₂O₃ powder mixed with the Ni particles to prepare the powder mixture as the raw material for the internal electrode patterns. The ratio of the Fe₂O₃ powder mixed was specifically set for samples 2 to 7 as follows. To fabricate sample 2, a powder mixture was prepared by mixing Ni powder with Fe₂O₃ powder in an amount corresponding to 0.03 at % relative to 100 at % Ni. To fabricate sample 3, a powder mixture was prepared by mixing Ni powder with Fe₂O₃ powder in an amount corresponding to 0.1 at % relative to 100 at % Ni. To fabricate sample 4, a powder mixture was prepared by mixing Ni powder with Fe₂O₃ powder in an amount corresponding to 0.3 at % relative to 100 at % Ni. To fabricate sample 5, a powder mixture was prepared by mixing Ni powder with Fe₂O₃ powder in an amount corresponding to 0.5 at % relative to 100 at % Ni. No Fe₂O₃ powder was mixed for fabricating sample 6. To fabricate sample 7, a powder mixture was prepared by mixing Ni powder with Fe₂O₃ powder in an amount corresponding to 0.7 at % relative to 100 at % Ni. Samples 2 to 7 were fabricated in the same manner as sample 1 using the alternative internal electrode slurries respectively including the powder mixtures prepared as described above.

### (3-2) Verification of Intermediate Layer

Each of samples 1 to 7 was sliced using a focused ion beam (FIB) system so that an LT plane can become the observation surface. A sliced analysis specimen with a thickness of 60 nm was taken from each of samples 1 to 7. Damage that appeared on the observation surface of the sliced specimen was removed as appropriate by Ar ion milling. Next, the analysis specimen was placed in a TEM equipped with an EDS detector, and ten observation regions (each corresponding to the observation region A1 in FIG. 3) of 15 nm square extending from an internal electrode layer to a dielectric layer were set on the observation surface and subjected to EDS analysis. Specifically, concentration maps representing the concentrations of the quantitative elements (Ba, Ti, O, Ni, and Fe) in atomic ratio (at %) were obtained for each observation region and reconstructed along a scanning line SL (equivalent to the scanning line SL in FIG. 3) extending along the T-axis from the internal electrode layer to the dielectric layer within each observation region. In this way, the line profiles of the quantitative elements were obtained for each observation region. In the line profiles of samples 1 to 5 and sample 7, the peak of Fe appeared near the intersection of the Ba and Ni profiles similarly to what is shown in FIG. 5. For sample 6, Fe was detected only due to system noise. The results of the line analysis confirmed that an intermediate layer where Fe was concentrated was formed between a dielectric layer and an internal electrode layer in samples 1 to 5 and sample 7. The TEM used was the NEOARM available from JEOL Ltd. The EDS analysis was performed using an Octane Elite energy dispersive X-ray spectroscopy detector manufactured by Ametek, Inc. The EDS analysis was performed with the acceleration voltage being set at 200 KV and the electron beam diameter 1.0 nm for a duration of 3 hours.

### (3-3) Analysis of Fe Concentration

Next, the concentration of Fe at the interfaces (in the intermediate layers) between the internal electrode layers and the dielectric layers, and the concentration of Fe within the internal electrode layers were analyzed for each sample except sample 6, for which the Fe-containing powder was not added to the raw material, as follows. In the analysis specimen used to verify the presence of the intermediate layer, ten observation regions (each corresponding to the observation region A1 in FIG. 3) extending from an internal electrode layer to a dielectric layer were set and the concentration of Fe in the intermediate layer was measured for the ten observation regions. The average of the Fe concentration values measured in these ten observation regions was calculated. The average of the Fe concentration values measured in the 10 observation regions set over the intermediate layer is treated as the Fe concentration of the intermediate layer for each sample and is listed in the “Fe Concentration of Intermediate Layer” column in Table 1 below.

Subsequently, in the analysis specimen used to quantify the Fe concentration of the intermediate layer, ten regions (each corresponding to the region A2 in FIG. 3) near the middle in the lamination direction of an internal electrode layer were set. The Fe concentration was then measured in the ten observation regions near the middle in the lamination direction of the internal electrode layer. The average of the Fe concentration values measured in these ten observation regions was calculated. The average of the Fe concentration values measured in the 10 observation regions is treated as the Fe concentration of the internal electrode layer of each sample and listed in the “Fe Concentration of Internal Electrode Layer” column in Table 1 below. In samples 1 to 5 and sample 7, degradation in insulation reliability due to hydrogen diffusion from the first internal electrode layers 21 can be suppressed, as the first internal electrode layers 21 contain Fe at the first concentration of at least 0.01 at %.

The ratio of the Fe concentration of the intermediate layer to that of the internal electrode layer was calculated and listed in the “Fe Concentration Ratio” column of Table 1. Samples 1 to 5 and sample 7 all have Fe concentration ratios equal to or greater than 3. In other words, the Fe concentration of the intermediate layer is equal to or greater than three times that of the internal electrode layer in samples 1 to 5 and sample 7. Since, in samples 1 to 5, the Fe concentration of the intermediate layer is at least three times that of the internal electrode layer, the resulting increase in the height of the Schottky barrier formed between the dielectric layers 11 and the second internal electrode layers 21 contributes to improved insulation reliability of the laminated ceramic capacitor 1.

### (3-4) Capacitance

One hundred pieces were selected for each of samples 1 to 7, and capacitance was measured under the conditions of 0.5V and 1 kHz using an LCR meter for each of the selected pieces. The average of the capacitance values measured for the 100 pieces was calculated as an average capacitance value. The results confirmed that the calculated average capacitance value decreases as the Fe concentration of the intermediate layer increases. The average capacitance values calculated in the above manner for samples 1 to 5 and sample 7 were compared with the average capacitance value of sample 6, for which no Fe-containing powder was added to the raw material. Samples exhibiting a decrease of 10% or less in average capacitance value compared to that of sample 6 were judged as passing, while those with a decrease of 10% or more were judged as failing. The results for the respective samples are listed in the “Capacitance Characteristic” column of Table 1. The samples judged as passing are likely to sufficiently suppress degradation in capacitance caused by the Fe diffusion into the dielectric layers.

### (3-5) Reliability Test

One hundred pieces were selected for each of samples 1 to 7, and a reliability test was performed on each of these selected pieces. The reliability test was performed as follows: the selected pieces were subjected to a voltage of 10 V at 150° C. for 1000 hours, then left at room temperature for 24 hours. The insulation resistance was subsequently measured. Samples with one or more pieces exhibiting an insulation resistance of less than 10 kΩ were judged as failing, and those with no pieces exhibiting an insulation resistance of less than 10 kΩ were judged passing. The results for the respective samples are listed in the “Insulation Reliability” column of Table 1.

TABLE 1

| | Fe Concen- | Fe Concen- | Fe | Capac- | |
|---|---|---|---|---|---|
| | tration of | tration of | Concen- | itance | |
| Sample | Intermediate | Internal Electrode | tration | Charac- | Insulation |
| Number | Layer [at %] | Layer [at %] | Ratio | teristic | Reliability |
| 1 | 0.04 | 0.01 | 4 | Pass | Pass |
| 2 | 0.1 | 0.03 | 3.3 | Pass | Pass |
| 3 | 0.5 | 0.1 | 5 | Pass | Pass |
| 4 | 0.9 | 0.3 | 3 | Pass | Pass |
| 5 | 2 | 0.4 | 5 | Pass | Pass |
| 6* | 0 | 0 | 0 | Pass | Fail |
| 7* | 2.5 | 0.6 | 4.1 | Fail | Pass |

In Table 1, the samples not encompassed by the present invention (i.e., comparative examples) have an asterisk (*) added to the sample number. Specifically, samples 6 and 7 are comparative examples not encompassed by the present invention.

The above verification demonstrates that the capacitance decreases with increasing Fe concentration of the intermediate layer. Accordingly, high capacitance can be reliably achieved by reducing the Fe concentration of the intermediate layer. In one aspect, excellent capacitance can be ensured by limiting the Fe concentration of the intermediate layer to 2.0 at % or less. The above verification also confirms that excellent insulation reliability can be exhibited when the Fe concentration of the intermediate layer is set equal to or greater than three times that of the internal electrode layer and the internal electrode layer contains Fe at 0.01 at % or more. As a consequence, the experimental results confirm that high effective capacitance and excellent insulation reliability can be achieved when the internal electrode layer has a Fe concentration of 0.01 at % or greater, and the Fe concentration of the intermediate layer is equal to or greater than three times that of the internal electrode layer while being 2 at % or less.

### (4) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) Additional Embodiments

Embodiments disclosed herein also include the following.

### Additional Embodiment 1

A laminated ceramic capacitor comprising:
a body having:
   a first internal electrode layer containing a main component metal and Fe, the first internal electrode layer containing Fe at a first concentration;
   a second internal electrode layer;
   a dielectric layer disposed between the first and second internal electrode layers in a first direction; and
   a first intermediate layer disposed between the first internal electrode layer and the dielectric layer, the first intermediate layer containing Fe at a second concentration,
a first external electrode provided on the body so as to be electrically connected to the first internal electrode layer, the first external electrode including a Ni plating layer; and
a second external electrode provided on the body so as to be electrically connected to the second internal electrode layer,
wherein the first concentration is 0.01 at % or greater, and
wherein the second concentration is equal to or greater than three times the first concentration while being 2 at % or less.

### Additional Embodiment 2

The laminated ceramic capacitor of [Additional Embodiment 1], wherein the first and second internal electrode layers are mainly composed of Ni.

### Additional Embodiment 3

The laminated ceramic capacitor of [Additional Embodiment 1] or [Additional Embodiment 2], wherein a dimension of the first internal electrode layer in the first direction is 0.1 μm to 2 μm.

### Additional Embodiment 4

The laminated ceramic capacitor of any one of [Additional Embodiment 1] to [Additional Embodiment 3],
wherein the second external electrode includes a Ni plating layer,
wherein the second internal electrode layer contains Fe at a third concentration,
wherein the body further has a second intermediate layer disposed between the second internal electrode layer and the dielectric layer in the first direction, the second intermediate layer containing Fe at a fourth concentration,
wherein the third concentration is 0.01 at % or greater, and
wherein the fourth concentration is equal to or greater than three times the third concentration while being 2 at % or less.

### Additional Embodiment 5

A circuit module including the laminated ceramic capacitor of any one of [Additional Embodiment 1] to [Additional Embodiment 4].

### Additional Embodiment 6

An electronic device including the circuit module of [Additional Embodiment 5].

### Additional Embodiment 7

A method of manufacturing a capacitor, the method comprising the steps of:
preparing a laminate including a dielectric green sheet and an internal electrode pattern provided on a first surface and a second surface of the dielectric green sheet, the internal electrode pattern containing Ni and Fe;
performing a first heating process to heat the laminate at a first temperature that is equal to or greater than 850° C.;
increasing a temperature from the first temperature to a second temperature that is equal to or greater than 1150° C. at a rate of 3000° C./h or greater; and
performing a second heating process to heat the laminate at the second temperature.

What is claimed is:

1. A laminated ceramic capacitor comprising:
a body having:
a first internal electrode layer containing a main component metal and Fe, the first internal electrode layer containing Fe at a first concentration;
a second internal electrode layer;
a dielectric layer disposed between the first and second internal electrode layers in a first direction; and
a first intermediate layer disposed between the first internal electrode layer and the dielectric layer, the first intermediate layer containing Fe at a second concentration,
a first external electrode provided on the body so as to be electrically connected to the first internal electrode layer, the first external electrode including a Ni plating layer; and
a second external electrode provided on the body so as to be electrically connected to the second internal electrode layer,
wherein the first concentration is 0.01 at % or greater, and
wherein the second concentration is equal to or greater than three times the first concentration while being 2 at % or less.

2. The laminated ceramic capacitor of claim 1, wherein the first and second internal electrode layers are mainly composed of Ni.

3. The laminated ceramic capacitor of claim 1, wherein a dimension of the first internal electrode layer in the first direction is 0.1 μm to 2 μm.

4. The laminated ceramic capacitor of claim 1,
wherein the second external electrode includes a Ni plating layer,
wherein the second internal electrode layer contains Fe at a third concentration,
wherein the body further has a second intermediate layer disposed between the second internal electrode layer and the dielectric layer in the first direction, the second intermediate layer containing Fe at a fourth concentration,
wherein the third concentration is 0.01 at % or greater, and
wherein the fourth concentration is equal to or greater than three times the third concentration while being 2 at % or less.

5. A circuit module comprising the laminated ceramic capacitor of claim 1.

6. An electronic device comprising the circuit module of claim 5.

7. A method of manufacturing a capacitor, the method comprising the steps of:
preparing a laminate including a dielectric green sheet and an internal electrode pattern provided on a first surface and a second surface of the dielectric green sheet, the internal electrode pattern containing Ni and Fe;
performing a first heating process to heat the laminate at a first temperature that is equal to or greater than 850° C.;
increasing a temperature from the first temperature to a second temperature that is equal to or greater than 1150° C. at a rate of 3000° C./h or greater; and
performing a second heating process to heat the laminate at the second temperature.
